(19) United States
(12) Patent Application Publication
(10) Pub. No.: US 2009/0315486 A1
(43) Pub. Date: Dec. 24, 2009

(54) LIGHT EMITTING DEVICE AND ELECTRONIC APPARATUS

(75) Inventor: Shinpei NOSHITA, Suwa-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/472,690

(22) Filed: May 27, 2009

(30) Foreign Application Priority Data
Jun. 20, 2008 (JP) 2008-161386
Mar. 12, 2009 (JP) 2009-059046

(51) Int. Cl. H05B 37/00

(52) U.S. Cl. 315/324

(57) ABSTRACT

A light emitting device having an element group, a plurality of first driving circuits and a plurality of second driving circuits is provided. The element group is constituted by a plurality of light emitting elements arranged in a first direction. Each of the first driving circuits is configured to drive a corresponding one of a plurality of first light emitting elements belonging to the element group. Each of the second driving circuits is configured to drive a corresponding one of a plurality of second light emitting elements belonging to the element group. At least a portion of the element group is arranged between the first driving circuits and the second driving circuits in a second direction being different from the first direction. A semiconductor layer of at least one transistor included in each of the first driving circuits and a semiconductor layer of at least one transistor included in each of the second driving circuits are arranged at the same positions in the first direction.

This application claims priority to JP 2009-059046 filed in Japan on Mar. 12, 2009, and to JP 2008-161386 filed in Japan on Jun. 20, 2008, the entire disclosures of which are hereby incorporated by reference in their entireties.

### BACKGROUND

1. Technical Field

The present invention relates to a light emitting device and an electronic apparatus.

2. Related Art

An image forming device of an electronic photo system uses a light emitting device having a plurality of light emitting elements provided on a substrate as a light head for forming an electrostatic latent image on an image carrier such as a photosensitive drum. In order to make an image (latent image) that the image forming device forms on the image carrier be of a higher resolution, a technology for narrowing a pitch of light emitting elements can be thought of. According to JP-A-2001-205847, e.g., as shown in FIG. 14, an element group is constituted by a plurality of light emitting elements arranged along a main scan direction (in the X direction shown in FIG. 14), and a plurality of driving circuits each of which is configured to drive a corresponding one of the light emitting elements are arranged on both sides of the element group (the positive and negative sides in the Y direction shown in FIG. 14 as viewed from the element group). According to the configuration of JP-A-2001-205847, as the pitch of the light emitting elements can be narrowed in comparison with a configuration in which a plurality of driving circuits are arranged on one side of the element group (either one of the positive and negative sides in the Y direction shown in FIG. 14 as viewed from the element group), the image can be made to be of a higher resolution.

Meanwhile, the above light emitting device has the plural light emitting elements constituting the element group and the plural driving circuits formed on the same substrate, and the driving circuits each include a thin film transistor configured to be used for controlling a driving current provided to the light emitting element. In a process for forming a semiconductor layer of the thin film transistor included in the driving circuit on the substrate, a laser irradiates the substrate so as to crystallize silicon. As shown in FIG. 14, the laser performs irradiation while the area being irradiated is successively moved in the Y direction. The area having been irradiated once is surrounded by a dotted line shown in FIG. 14. As shown in FIG. 14, a longer side direction of the area having been irradiated once extends in the X direction in which each of the driving circuits is arranged.

In some cases, the amount of laser light may vary depending on a position in the longer side direction (the X direction shown in FIG. 14) of the area having been irradiated once. In the configuration shown in FIG. 14, the position in the X direction of the driving circuit P arranged on the negative side of the Y direction and the position in the X direction of the driving circuit Q arranged on the positive side of the Y direction are different as viewed from the element group. Thus, if the amount of the laser light varies depending on the position in the X direction, the amount of the laser light that irradiates the driving circuit P and the amount of the laser light that irradiates the driving circuit Q are different. This causes a problem in that the characteristics of the driving circuit P and the driving circuit Q are different.

### SUMMARY

An advantage of some aspects of the invention is that it reduces the variation of the characteristics of the driving circuits provided on both sides of the element group.

In order to address the above problem, an aspect of the invention is to provide a light emitting device having an element group, a plurality of first driving circuits and a plurality of second driving circuits. The element group is constituted by a plurality of light emitting elements arranged in a first direction. Each of the first driving circuits is configured to drive a corresponding one of a plurality of first light emitting elements belonging to the element group. Each of the second driving circuits is configured to drive a corresponding one of a plurality of second light emitting elements belonging to the element group. At least a portion of the element group is arranged between the first driving circuits and the second driving circuits in a second direction being different from the first direction. A semiconductor layer of at least one transistor included in each of the first driving circuits and a semiconductor layer of at least one transistor included in each of the second driving circuits are arranged at the same positions in the first direction.

Another aspect of the invention is to provide a light emitting device having a substrate, an element group, a first driving circuit and a second driving circuit. The substrate includes a first area, a second area and a third area. The first area is positioned between the second area and the third area. The element group includes a first light emitting element, a second light emitting element, a third light emitting element and a fourth light emitting element. The element group is arranged in the first area. The first driving circuit is arranged in the second area. The first driving circuit is configured to drive the first light emitting element. The first driving circuit includes a first transistor. The second driving circuit is arranged in the third area. The second driving circuit is configured to drive the second light emitting element. The second driving circuit includes a second transistor. A semiconductor layer of the first transistor is arranged opposite a semiconductor layer of the second transistor with respect to the first area. The third driving circuit is arranged in the second area. The third driving circuit is configured to drive the third light emitting element. The third driving circuit includes a third transistor. The fourth driving circuit is arranged in the third area. The fourth driving circuit is configured to drive the fourth light emitting element. The fourth driving circuit includes a fourth transistor. A semiconductor layer of the third transistor is arranged opposite a semiconductor layer of the fourth transistor with respect to the first area.

It is preferable that the light emitting device of the invention has a substrate, an element group, a first driving transistor, a second driving transistor, a third driving transistor and a fourth driving transistor. The substrate includes a first area, a second area and a third area. The first area is positioned between the second area and the third area. The element group includes a first light emitting element, a second light emitting element, a third light emitting element and a fourth light emitting element. The element group is arranged in the first area. The first driving transistor is arranged in the second area. The first driving transistor is arranged on a path of a driving current provided to the first light emitting element. The second driving transistor is arranged in the third area. The second driving transistor is arranged on a path of a driving current provided to the second light emitting element. A semiconductor layer of the first driving transistor is arranged opposite a semiconductor layer of the second driving transistor with respect to the first area. The third driving transistor is arranged in the second area. The third driving transistor is arranged on a path of a driving current provided to the third light emitting element. The fourth driving transistor is arranged in the third area. The fourth driving transistor is arranged on a path of a driving current provided to the fourth light emitting element. A semiconductor layer of the third driving transistor is arranged opposite a semiconductor layer of the fourth driving transistor with respect to the first area.

In order to address the above problem, the light emitting device of the invention has an element group, a plurality of first driving circuits and a plurality of second driving circuits. The element group is constituted by a plurality of light emitting elements arranged in a first direction. Each of the first driving circuits is configured to drive the corresponding one of a plurality of first light emitting elements belonging to the element group and arranged on the one side as viewed from the element group in a second direction that is different from the first direction. Each of the second driving circuits is configured to drive the corresponding one of a plurality of second light emitting elements belonging to the element group and arranged on the other side as viewed from the element group in the second direction. A semiconductor layer of at least one transistor included in the first driving circuit and a semiconductor layer of at least one transistor included in the second driving circuit are arranged at the same positions in the first direction.

In the above configuration, the semiconductor layer included in the first driving circuit and the semiconductor layer included in the second driving circuit are arranged at the same positions in the first direction. Thus, even in a case where an amount of laser light changes depending on a position in the first direction, variation between the amount of the laser light irradiated to the first driving circuit and the amount of the laser light irradiated to the second driving circuit arranged opposite the first driving circuit with respect to the element group can be reduced. Hence, the invention has an advantage in that variation of characteristics between the first driving circuit and the second driving circuit arranged opposite the first driving circuit with respect to the element group can be reduced.

It is preferable for the light emitting device of the invention that each of the first driving circuits includes a first driving transistor provided on a path of a current supplied to the corresponding one of the first light emitting elements, that each of the second driving circuits includes a second driving transistor provided on a path of a driving current supplied to the corresponding one of the second light emitting elements, and that a semiconductor layer of the first driving transistor and a semiconductor layer of the second driving transistor are arranged at the same positions in the first direction.

According to the above configuration, as variation of characteristics between the first driving transistor of the first driving circuit and the second driving transistor of the second driving circuit arranged opposite the first driving circuit with respect to the element group can be reduced, variation of driving currents which flow through the driving circuits (the first driving circuit and the second driving circuit) arranged opposite each other with respect to a central line of the element group.

It is preferable for the light emitting device of the invention that each of the first driving circuits includes a first selecting transistor configured to determine whether a data signal is provided to a gate of a first driving transistor provided on a path of a driving current supplied to each of the first light emitting elements, that each of the second driving circuits includes a second selecting transistor configured to determine whether a data signal is provided to a gate of a second driving transistor provided on a path of a driving current supplied to each of the second light emitting elements, and that a semiconductor layer of the first selecting transistor and a semiconductor layer of the second selecting transistor are arranged at the same positions in the first direction.

According to the above configuration, as variation of characteristics between the first selecting transistor of the first driving circuit and the second selecting transistor of the second driving circuit arranged opposite the first driving circuit with respect to the element group can be reduced, variation of values of electric charges which leak through the selecting transistors of the driving circuits (the first driving circuit and the second driving circuit). Thus, the light emitting device of the invention has an advantage in that variation of gate voltages of the driving transistors of the driving circuits can be reduced.

It is preferable for the light emitting device of the invention that each of the first driving circuits includes a first capacitor element having a first electrode and a second electrode formed from the same layer as the semiconductor layer of the first driving transistor included in the first driving circuit, and the first capacitor element is configured to maintain a gate voltage of the first driving transistor, that each of the second driving circuits includes a second capacitor element having a third electrode and a fourth electrode formed from the same layer as the semiconductor layer of the second driving transistor included in the second driving circuit, the second capacitor element is configured to maintain a gate voltage of the second driving transistor, and that the first capacitor element and the second capacitor element are arranged at the same positions in the first direction.

As variation of characteristics (resistance values) between the first capacitor element included in the first driving circuit and the second capacitor element included in the second driving circuit arranged opposite the first driving circuit with respect to the element group can be reduced, the above configuration has an advantage in that variation of gate voltages (and consequently driving current values) of the driving transistors of the driving circuits (the first driving circuit and the second driving circuit) can be reduced.

It is preferable for the light emitting device of the invention that the driving current flowing through the first driving transistor and the driving current flowing through the second driving transistor flow in a same direction. The above configuration has an advantage in that variation of the values of the driving current which flows through the driving transistor of the first driving circuit and the driving current which flows through the driving transistor of the second driving circuit arranged opposite the first driving circuit with respect to the element group can be reduced in comparison with a configuration in which a direction of the driving current that flows through the first driving transistor of the first driving circuit and a direction of the driving current that flows through the second driving transistor of the second driving circuit arranged opposite the first driving circuit with respect to the element group are different.

It is preferable for the light emitting device of the invention that the transistor included in the first driving circuit and the transistor included in the second driving circuit are arranged line-symmetrical with respect to a central line of the element group (e.g., straight lines A, B3 and H5 shown in FIGS. 2, 6 and 8, respectively) that extends in the first direction.

It is preferable for the light emitting device of the invention that an arrangement of elements in the first driving circuit and an arrangement of elements in the second driving circuit are line-symmetrical with respect to the central line of the element group (e.g., straight lines A, B3 and H5 shown in FIGS. 2, 6 and 8, respectively) that extends in the first direction. The arrangement of the elements in the driving circuits includes a position and a form (a shape, a size and a configuration) of each of the elements in the driving circuits.

It is preferable for the light emitting device of the invention that the plural light emitting elements are arranged so as to form an alternating pattern. As a pitch of the light emitting elements can decrease, the above configuration has an advantage in that the light emitting device can provide a high resolution image.

Then, an electronic apparatus of the invention has one of the light emitting devices described above as examples. The light emitting device of the invention can be applied to various kinds of electronic apparatuses. A typical example of the electronic apparatus of the invention is an image forming device of an electronic photo system having one of the light emitting devices described above for exposing an image carrier such as a photosensitive drum. The image forming device has an image carrier on which a latent image can be formed by the exposure, the light emitting device of the invention configured to expose the image carrier, and a developing unit configured to form a noticeable image by putting developer (e.g., toner) for the latent image on the image carrier.

### BRIEF DESCRIPTION OF THE DRAWINGS

The invention will be described with reference to the accompanying drawings, wherein like numbers reference like elements.

FIG. 1 is a perspective view partially showing a configuration of an image forming device of a first embodiment of the invention.

FIG. 2 is a plan view schematically showing a configuration of a light emitting device of the first embodiment.

FIG. 3 is a plan view specifically showing a structure of the light emitting device of the first embodiment.

FIG. 4 shows relative positions of elements in each of driving circuits.

FIG. 5 is a plan view of the light emitting device of the first embodiment.

FIG. 6 is a plan view schematically showing a configuration of the light emitting device.

FIG. 7 is a plan view specifically showing the structure of the light emitting device.

FIG. 8 shows relative positions of the elements in each of the driving circuits.

FIG. 9 is a plan view schematically showing a configuration of a light emitting device of a second embodiment.

FIG. 10 is a plan view specifically showing a structure of the light emitting device of the second embodiment.

FIG. 11 is a plan view schematically showing a configuration of a modification of the light emitting device of the invention.

FIG. 12 shows another example of laser irradiation.

FIG. 13 is a perspective view a specific example of an electronic apparatus (image forming device) of the invention.

FIG. 14 is a plan view schematically showing a configuration of an ordinary light emitting device.

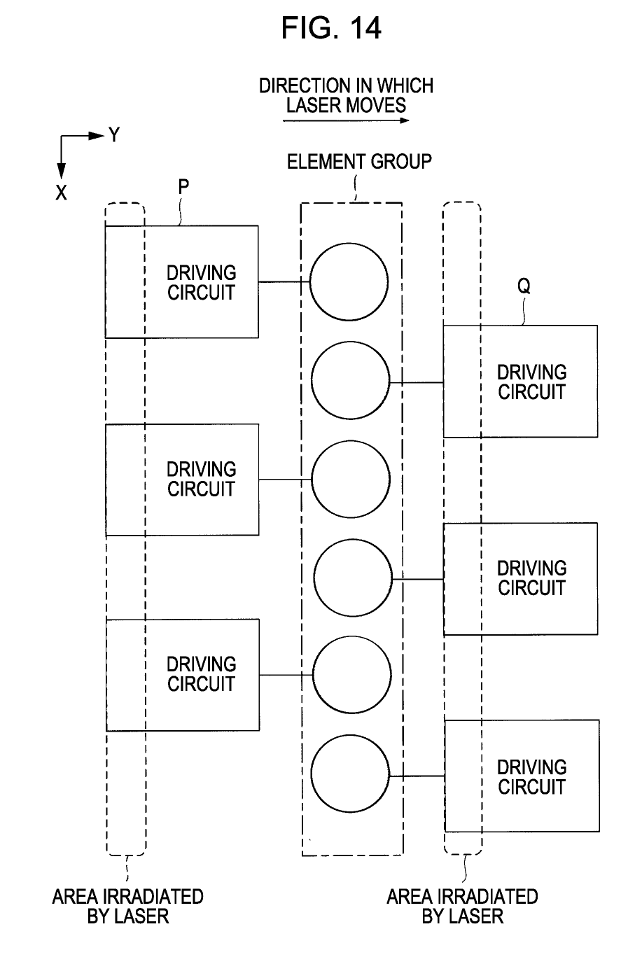

### DETAILED DESCRIPTION OF EMBODIMENTS

### A. First Embodiment

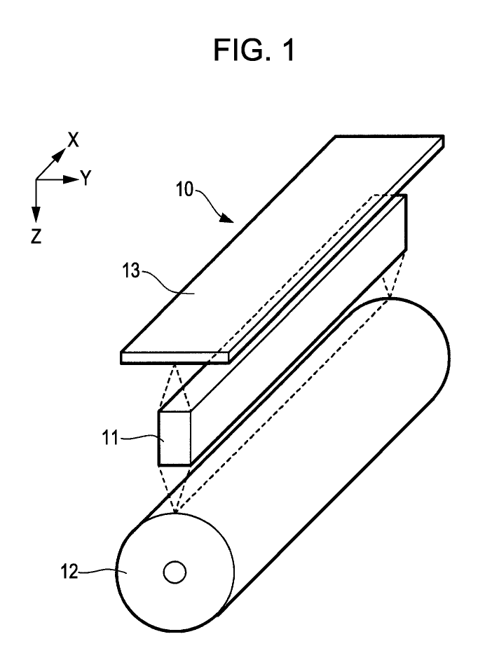

FIG. 1 is a perspective view partially showing a configuration of an image forming device using a light emitting device of a first embodiment of the invention as an exposure device (light head). As shown in FIG. 1, the image forming device has a light emitting device 10, a condenser lens array 11 and a photosensitive drum (image carrier) 12. The light emitting device 10 has a number of light emitting elements (not shown in FIG. 1) linearly provided on the surface of a substrate 13. These light emitting elements selectively emit light in accordance with a condition of an image to be printed on a recording medium such as a paper. The photosensitive drum 12 is supported by a rotation axle extending in the X direction (main scan direction). The photosensitive drum 12 rotates in the Y direction (sub scan direction in which the recording medium is carried) under a condition in which an outer surface of the photosensitive drum 12 faces the light emitting device 10.

The condenser lens array 11 is provided in a gap between the light emitting device 10 and the photosensitive drum 12. Light emitted from each of the light emitting elements of the light emitting device 10 permeates through each of lenses of the condenser lens array 11 and then reaches the surface of the photosensitive drum 12. This process of exposure forms a latent image (electrostatic latent image) in accordance with a desired image on the surface of the photosensitive drum 12.

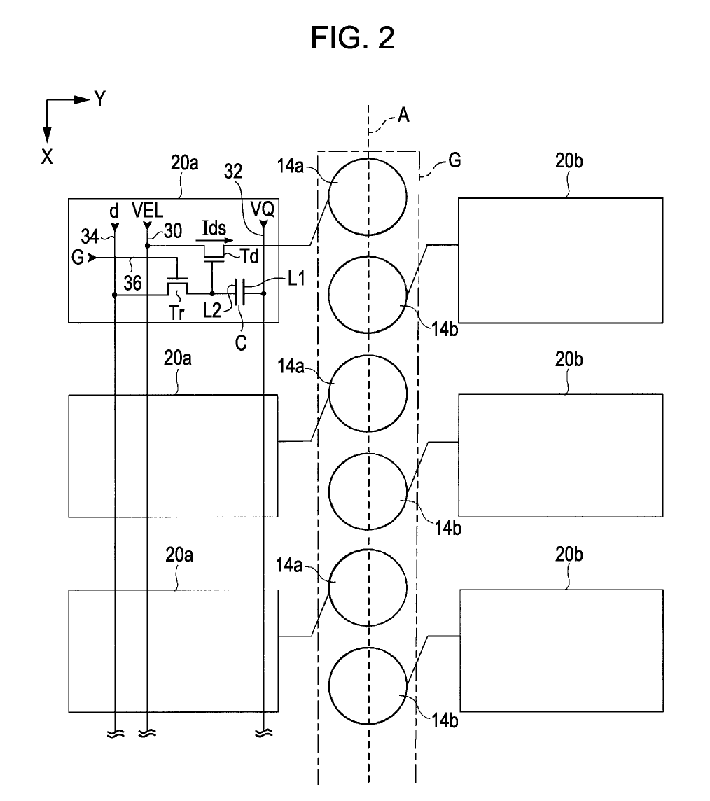

FIG. 2 is a plan view schematically showing a configuration of the light emitting device 10 of the first embodiment. An element group G is provided on the surface of the substrate 13. The element group G is constituted by a plurality of light emitting elements 14 (14a, 14b) provided in the X direction. As shown in FIG. 2, each of the light emitting elements 14 is centered on a straight line A extending in the X direction. The plural light emitting elements 14 of the first embodiment are constituted by a plurality of first light emitting elements 14a and a plurality of second light emitting elements 14b. As shown in FIG. 2, the first light emitting elements 14a and the second light emitting elements 14b are alternately arranged in the X direction. The light emitting element 14 of the first embodiment is an organic EL element including a light emitting layer made of organic EL substance interposed between an anode and a cathode.

As shown in FIG. 2, a plurality of first driving circuits 20a each of which drives a corresponding one of the plural first light emitting elements 14a are provided on the negative side of the Y direction as viewed from the element group G. The plural first driving circuits 20a are provided along the element group G and in the X direction. A plurality of second driving circuits 20b each of which drives a corresponding one of the plural second light emitting elements 14b are provided on the positive side of the Y direction as viewed from the element group G. The plural second driving circuits 20b are provided along the element group G and in the X direction. As shown in FIG. 2, the individual first driving circuits 20a and the individual second driving circuits 20b are arranged symmetrically with respect to the line A.

In FIG. 2, one of the first driving circuits 20a will be focused on and its configuration will be explained. As shown in FIG. 2, the first driving circuit 20a includes an N-channel driving transistor Td, an N-channel selecting transistor Tr and a capacitor element C.

The driving transistor Td is provided on a path of a driving current Ids provided to the first light emitting element 14a. As shown in FIG. 2, while the drain of the driving transistor Td is connected to a power supply line 30 to which a power supply voltage VEL is supplied, the source of the driving transistor Td is connected to the anode of the first light emitting element 14a. The driving current Ids supplied to the first light emitting element 14a has a value corresponding to the voltage of the gate of the driving transistor Td.

The capacitor element C is means for maintaining the voltage of the gate of the driving transistor Td. As shown in FIG. 2, the capacitor element C has a first electrode L1 and a second electrode L2. The first electrode L1 is connected to a maintaining capacitor line 32 to which a constant voltage VQ is supplied, and the second electrode L2 is connected to the gate of the driving transistor Td.

The selecting transistor Tr is means for determining whether the gate of the driving transistor Td is provided with a data signal d. As shown in FIG. 2, while the drain of the selecting transistor Tr is connected to a data line 34 to which the data signal d is provided, the source of the selecting transistor Tr is connected to the gate of the driving transistor Td and the second electrode L2 of the capacitor element C. The gate of the selecting transistor Tr is connected to a scan line 36 to which a scan signal G is provided. The selecting transistor Tr is turned on or off in accordance with the scan signal G provided to the gate of the selecting transistor Tr. If the selecting transistor Tr is turned on, the data signal d is provided from the data line 34 to the gate of the driving transistor Td and is written into the capacitor element C.

Each one of the first driving circuits 20a has the same configuration as the first driving circuits 20a described above, and so does each of the second driving circuits 20b.

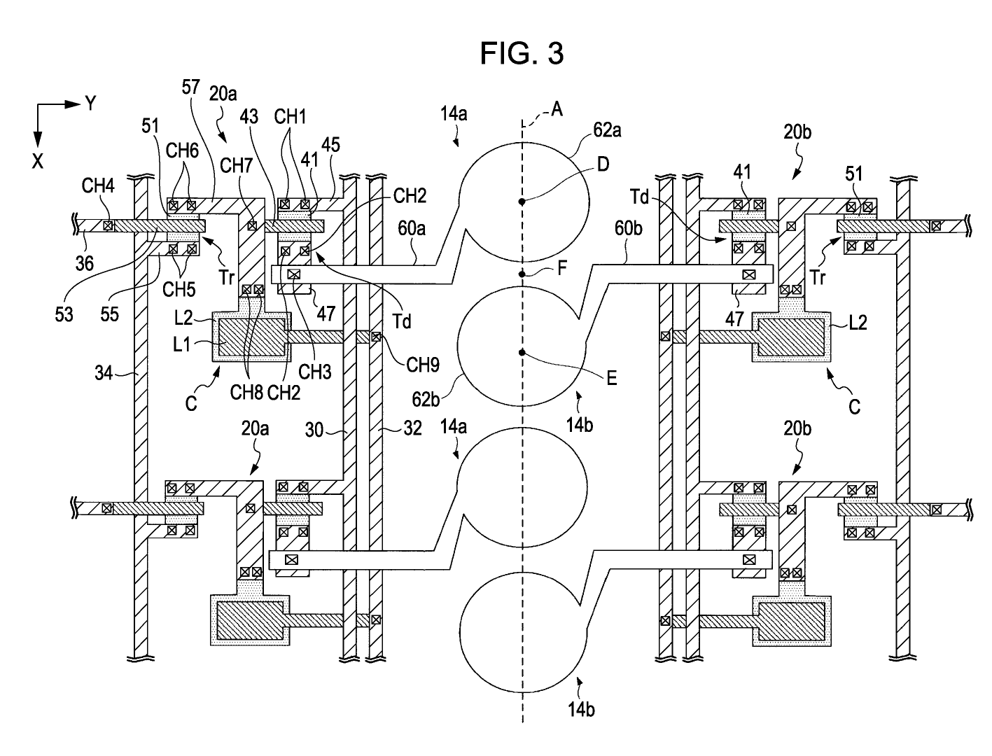

FIG. 3 is a plan view specifically showing a configuration of the light emitting device 10 of the first embodiment. A plurality of elements indicated by the same hatching in FIG. 3 are formed by the same process in which a common membrane (regardless of whether monolayer or multilayer) is selectively removed. In one case where a plurality of elements are formed by using the same process in which a common membrane is selectively removed, the expression “formed from the same layer” will be used hereafter. Between individual layers shown in FIG. 3, another layer such as an insulating layer is arranged but is not shown.

As shown in FIG. 3, the power supply line 30, the maintaining capacitor line 32 and the data line 34 are formed from the same layer, and each extend in the X direction. The elements of each of the driving circuits 20 are arranged in an area between the power supply line 30 and the data line 34. In FIG. 3, one of the first driving circuit 20a will be focused on, and a configuration of each of the elements included in the first driving circuit 20a will be explained. As shown in FIG. 3, a semiconductor layer 41 of the driving transistor Td is formed from the same layer as a semiconductor layer 51 of the selecting transistor Tr and the second electrode L2 of the capacitor element C. A gate layer 43 of the driving transistor Td is formed from the same layer as a gate layer 53 of the selecting transistor Tr and the first electrode L1 of the capacitor element C. A drain layer 45 of the driving transistor Td continues to the power supply line 30, and is electrically connected to the semiconductor layer 41 through a contact hole CH1. A source layer 47 of the driving transistor Td is formed from the same layer as the drain layer 45, and is electrically connected to the semiconductor layer 41 through a contact hole CH2 and connected to a wiring layer 60a through a contact hole CH3.

The wiring layer 60a continues to an anode 62a of the first light emitting element 14a. Although not shown in FIG. 3, a light emitting layer made of organic EL material is formed on the anode 62a, and a cathode is formed on the light emitting layer. Light emitted from the light emitting layer permeates through the anode 62a and the substrate 13, and then appears on the side of the photosensitive drum (image carrier) 12. That is, the light emitting device 10 of the first embodiment is of a bottom emission type.

In FIG. 3, the anode 62a of the first light emitting element 14a that continues to the wiring layer 60a and an anode 62b of the second light emitting element 14b that continues to a wiring layer 60b electrically connected to the source layer 47 included in the second driving circuit 20b are arranged point-symmetrically with respect to a midpoint F between a center D of the first light emitting element 14a and a center E of the second light emitting element 14b.

As shown in FIG. 3, the gate layer 53 of the selecting transistor Tr is connected to the scan line 36 through a contact hole CH4. The scan line 36 is formed from the same layer as the drain layer 45 of the driving transistor Td. A drain layer 55 of the selecting transistor Tr continues to the data line 34, and is electrically connected to the semiconductor layer 51 through a contact hole CH5. A source layer 57 of the selecting transistor Tr is formed from the same layer as the drain layer 45 of the driving transistor Td, and is electrically connected to the semiconductor layer 51 through a contact hole CH6. As shown in FIG. 3, the source layer 57 of the selecting transistor Tr is electrically connected to the gate layer 43 of the driving transistor Td through a contact hole CH7, and is electrically connected to the second electrode L2 of the capacitor element C through a contact hole CH8.

As shown in FIG. 3, the first electrode L1 of the capacitor element C is electrically connected to the maintaining capacitor line 32 through a contact hole CH9.

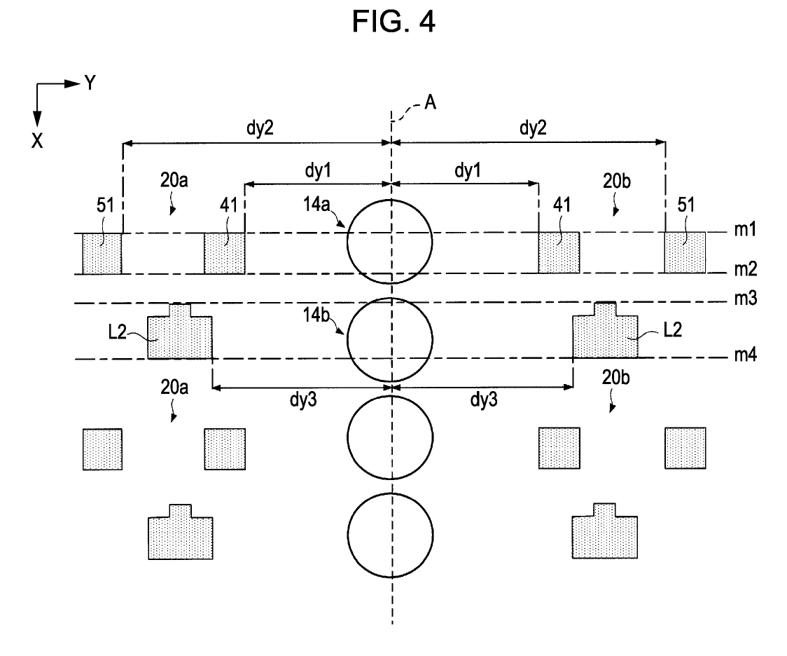

As shown in FIG. 3, the arrangement (layout) of the elements of the first driving circuit 20a (particularly the driving transistor Td, the selecting transistor Tr and the capacitor element C) and the arrangement of the elements of the second driving circuit 20b are line-symmetrical with respect to a central line A of the element group G. This symmetrical configuration will be specifically explained with reference to FIG. 4 that schematically shows positions of the semiconductor layers 41 and 51 and the second electrode L2 of the capacitor element C included in the first driving circuit 20a relative to the semiconductor layers 41 and 51 and the second electrode L2 of the capacitor element C included in the second driving circuit 20b.

As described below, the semiconductor layer 41 of the driving transistor Td of the first driving circuit 20a and the semiconductor layer 41 of the driving transistor Td of the second driving circuit 20b are line-symmetrical with respect to the central line A of the element group G. First, the semiconductor layer 41 of the first driving circuit 20a and the semiconductor layer 41 of the second driving circuit 20b are arranged at the same positions in the X direction. That is, as shown in FIG. 4, both the semiconductor layer 41 included in the first driving circuit 20a and the semiconductor layer 41 included in the second driving circuit 20b are formed to span from a straight line m1 to a straight line m2 both extending in the Y direction while being spaced apart from each other. Furthermore, the semiconductor layer 41 included in the first driving circuit 20a and the semiconductor layer 41 included in the second driving circuit 20b have the same shape and size. Further, the semiconductor layer 41 included in the first driving circuit 20a and the semiconductor layer 41 included in the second driving circuit 20b are equal distances (dy1 shown in FIG. 4) from the central line A.

Similarly, the semiconductor layer 51 of the selecting transistor Tr of the first driving circuit 20a and the semiconductor layer 51 of the selecting transistor Tr of the second driving circuit 20b are line-symmetrical with respect to the central line A. That is, the semiconductor layer 51 of the selecting transistor Tr included in the first driving circuit 20a and the semiconductor layer 51 of the selecting transistor Tr included in the second driving circuit 20b are arranged at the same position in the X direction and have the same shape and size, and are equal distances (dy2 shown in FIG. 4) from the central line A.

Similarly, the second electrode L2 of the capacitor element C of the first driving circuit 20a and the second electrode L2 of the capacitor element C of the second driving circuit 20b are line-symmetrical with respect to the central line A. First, the second electrode L2 included in the first driving circuit 20a and the second electrode L2 included in the second driving circuit 20b are arranged at the same positions in the X direction. That is, as shown in FIG. 4, both the second electrode L2 included in the first driving circuit 20a and the second electrode L2 included in the second driving circuit 20b are formed to span from a straight line m3 to a straight line m4 both extending in the Y direction while being spaced apart from each other. Besides, the second electrode L2 included in the first driving circuit 20a and the second electrode L2 included in the second driving circuit 20b have the same shape and size, and equal distances (dy3 shown in FIG. 4) from the central line A.

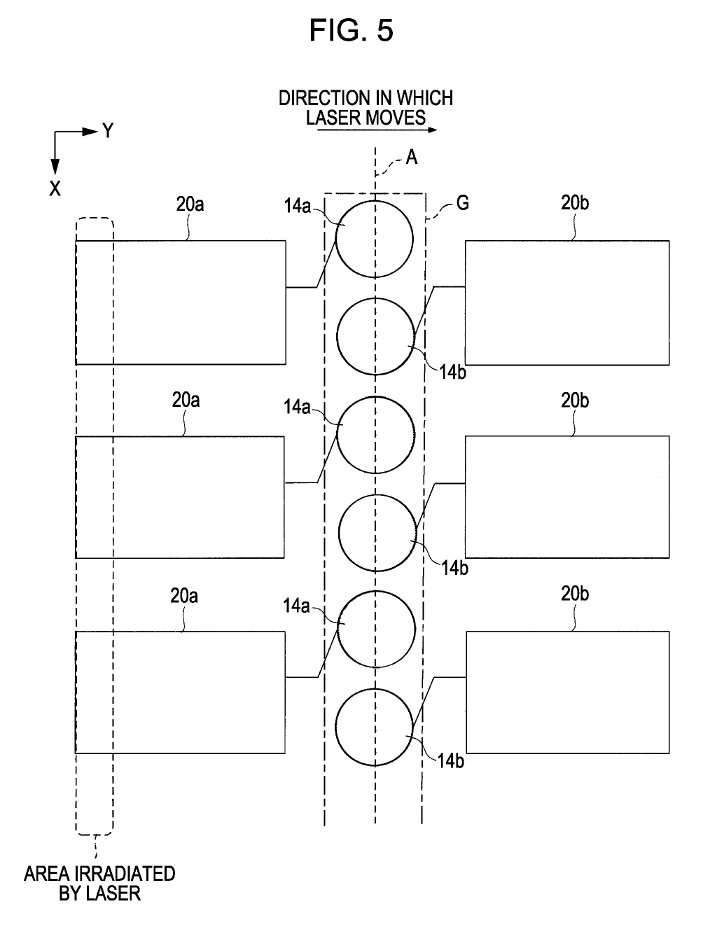

Incidentally, the semiconductor layers 41, 51 and the second electrode L2 of the capacitor element C are poly-silicon membranes of amorphous silicon formed by being illuminated by laser light (laser annealed). As shown in FIG. 5, the laser irradiates each of the semiconductor layers 41, 51 and the second electrodes L2 while an area being irradiated is successively moved in the Y direction. The area having been irradiated once is surrounded by a dotted line shown in FIG. 5. As shown in FIG. 5, a longer side direction of the area having been irradiated once extends in the X direction in which the driving circuits 20 are arranged. Furthermore, in some cases, the amount of laser light may vary depending on a position in the longer side direction (the X direction) of the area having been irradiated once.

The semiconductor layer 41 included in the first driving circuit 20a and the semiconductor layer 41 included in the second driving circuit 20b of the first embodiment are arranged at the same positions in the X direction. Thus, even in a case where an amount of the laser light varies depending on a position in the X direction, variation of the amount of laser light irradiated to the semiconductor layer 41 of each of the driving circuits 20 (20a, 20b) which are positioned opposite each other with respect to the central line A can be reduced. Hence, variation of characteristics of the driving transistor Td included in the first driving circuit 20a and the driving transistor Td included in the second driving circuit 20b arranged opposite the first driving circuit 20a with respect to the central line A (on the positive side in the Y direction as viewed from the first driving circuit 20a) can be reduced. Thus, variation between a value of the driving current Ids that flows through the first driving circuit 20a and a value of the driving current Ids that flows through the second driving circuit 20b arranged opposite the first driving circuit 20a with respect to the central line A can be reduced.

In addition, as the semiconductor layer 51 included in the first driving circuit 20a and the semiconductor layer 51 included in the second driving circuit 20b of the first embodiment are arranged at the same positions in the X direction, variation of the amount of the laser light irradiated to the semiconductor layer 51 of each of the driving circuits 20 (20a, 20b) positioned opposite each other with respect to the central line A can be reduced. Thus, variation of characteristics of the selecting transistors Tr included in the driving circuits 20 (20a, 20b) can be reduced.

In some cases, electric charge held by the capacitor element C leaks to the data line 34 through the selecting transistors Tr. As the variation of the characteristics of the selecting transistors Tr of the driving circuits 20 (20a, 20b) of the first embodiment is reduced, variation of values of electric charge which leak from the capacitor elements C through the selecting transistors Tr can be reduced. Thus, variation of changes of gate voltage values of the selecting transistors Tr included in the driving circuits 20 (20a, 20b) positioned opposite each other with respect to the central line A can be reduced.

Further, as the second electrode L2 included in the first driving circuit 20a and the second electrode L2 included in the second driving circuit 20b of the first embodiment are arranged at the same positions in the X direction, variation of an amount of laser light irradiated to the second electrode L2 of each of the driving circuits 20 (20a, 20b) positioned opposite each other with respect to the central line A can be reduced. Thus, as variation of characteristics (resistance values) of the capacitor elements C included in the driving circuits 20 (20a, 20b) can be reduced, variation of gate voltage values of the driving transistors Td of the driving circuits 20 (20a, 20b) (and consequently variation of values of the driving currents Ids) can be reduced.

That is, as the arrangement of the elements of the first driving circuit 20a and the arrangement of the elements of the second driving circuit 20b of the first embodiment are line-symmetrical with respect to the central line A, variation of characteristics of the driving circuits 20 (20a, 20b) positioned opposite each other with respect to the central line A (and consequently variation of values of the driving currents Ids) can be reduced. Hence, the first embodiment has an advantage in that variation between an amount of light emitted by the first light emitting element 14a driven by the first driving circuit 20a and an amount of light emitted by the second light emitting element 14b driven by the second driving circuit 20b arranged opposite the first driving circuit 20a with respect to the central line A can be reduced (that is, variation of the amounts of light between the first light emitting element 14a and the second light emitting element 14b arranged adjacent thereto in the X direction can be reduced).

As the arrangement of the elements of the first driving circuit 20a and the arrangement of the elements of the second driving circuit 20b of the first embodiment are line-symmetrical with respect to the central line A, the driving current Ids that flows through the driving transistor Td of the first driving circuit 20a (flowing from the drain area to the source area of the semiconductor layer 41) and the driving current Ids that flows through the driving transistor Td of the second driving circuit 20b flow in the same direction (toward the positive side of the X direction of the first embodiment). Thus, the first embodiment has an advantage in that variation of values of the driving currents Ids which flow through the driving circuits 20 (20a, 20b) can be reduced in comparison with a configuration in which the driving currents Ids which flow through the driving circuits 20 (20a, 20b) flow in opposite directions.

In addition, as shown in FIG. 3, it is preferable that the center D of the first light emitting element 14a is positioned relative to the driving transistor Td in the same way as the center E of the second light emitting element 14b is positioned relative to the driving transistor Td. Moreover, it is preferable that the wiring 60a connecting the anode 62a and the driving transistor Td is formed so as to have the same length as the wiring 60b connecting the anode 62b and the driving transistor Td. Hence, resistance values between the first light emitting element 14a and the driving transistor Td and between the second light emitting element 14b and the driving transistor Td can be made even.

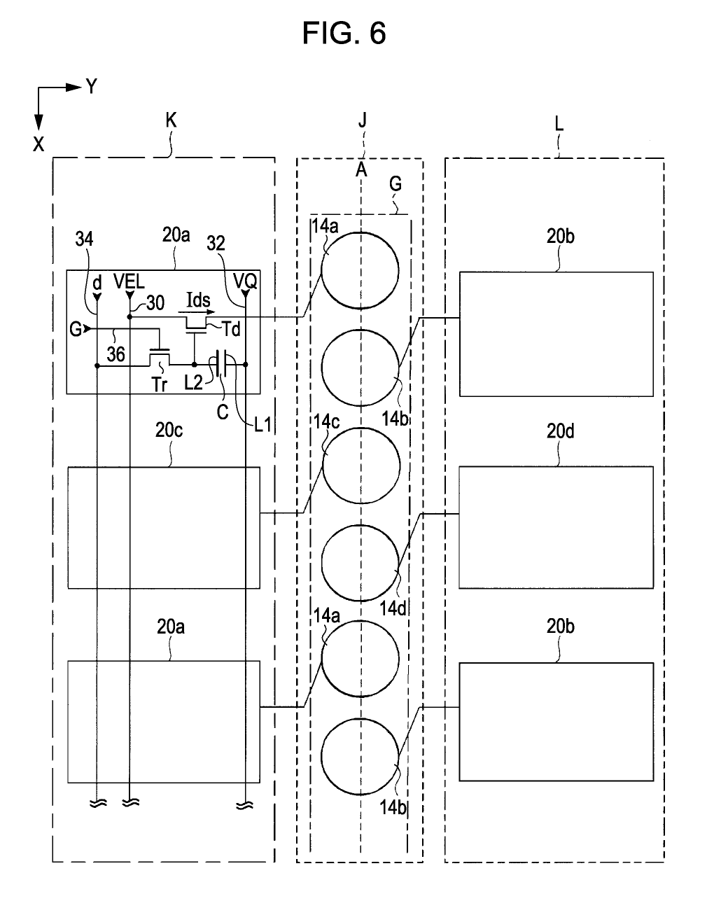

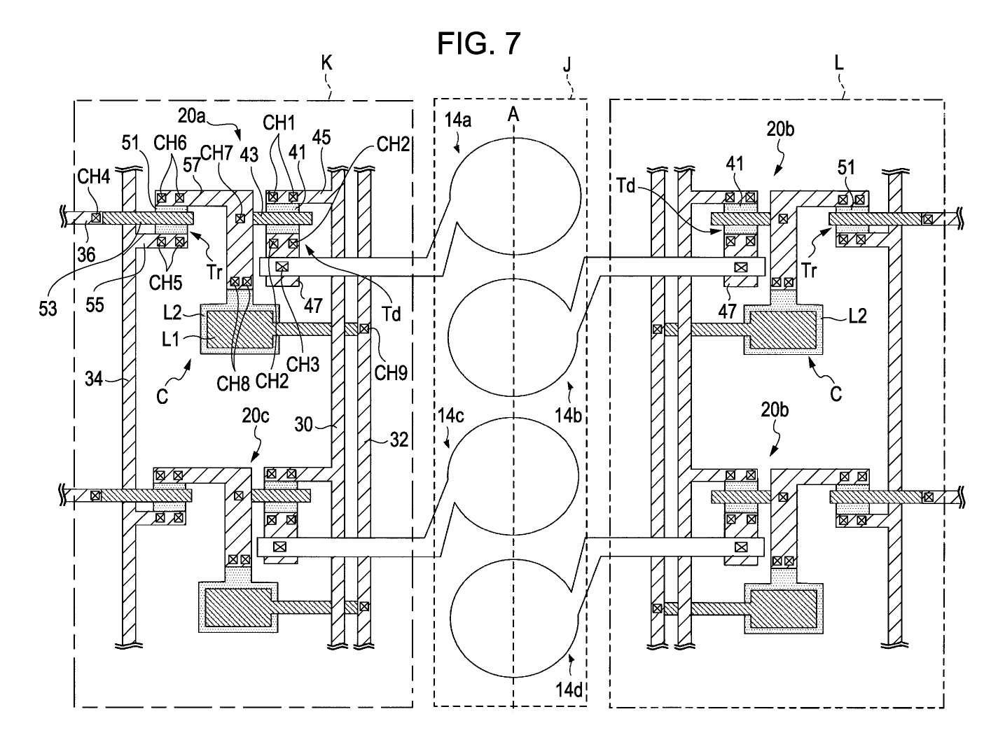

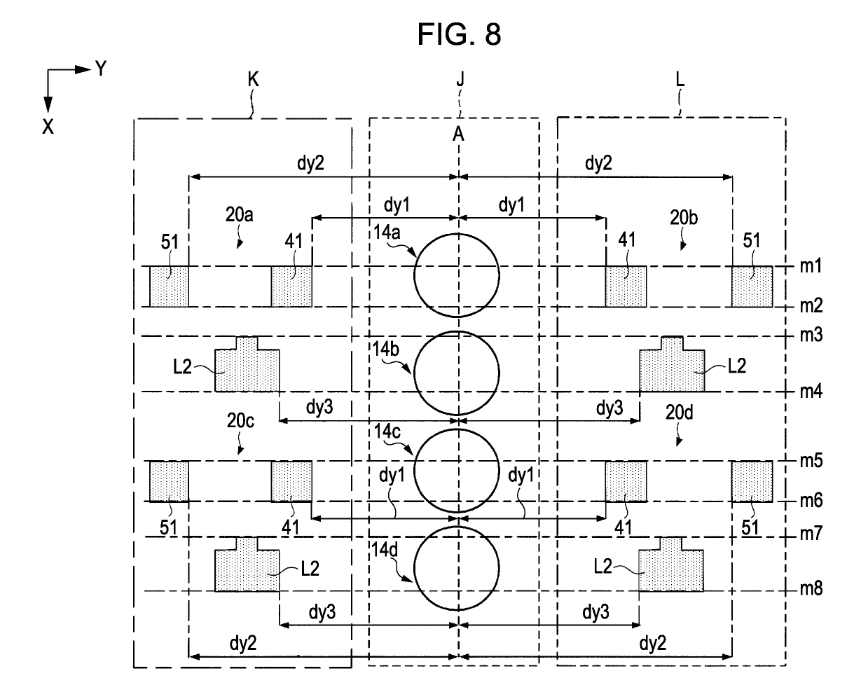

From another viewpoint of the invention, the light emitting device 10 described above can be grasped in a configuration shown in FIGS. 6-8. FIG. 6 is a plan view schematically showing a configuration of the light emitting device 10 (corresponding to FIG. 2). FIG. 7 is a plan view specifically showing a configuration of the light emitting device 10 (corresponding to FIG. 3). FIG. 8 schematically shows positions of the elements included in the driving circuit 20 relative to each other (corresponding to FIG. 4).

As shown in FIGS. 6 and 7, the element group G is provided in a first area J on the substrate 13. The element group G is constituted by a plurality of light emitting elements 14, i.e., a first light emitting element 14a, a second light emitting element 14b, a third light emitting elements 14c and a fourth light emitting element 14d. A first driving circuit 20a and a second driving circuit 20b which drive the first light emitting element 14a and the third light emitting element 14c, respectively, are provided in a second area K on the substrate 13. A second driving circuit 20b and a fourth driving circuit 20d which drive the second light emitting element 14b and the fourth light emitting element 14d, respectively, are provided in a third area L on the substrate 13. The first area J is positioned between the second area K and the third area L.

Then, the semiconductor layer of at least one transistor included in the first driving circuit 20a is arranged opposite at least one of the semiconductor layers included in the second driving circuit 20b with respect to the first area J. More specifically, the semiconductor layer 41 of the driving transistor Td of the first driving circuit 20a is arranged opposite the semiconductor layer 41 of the driving transistor Td of the second driving circuit 20b with respect to the first area J. In further detail, it is preferable that the semiconductor layer 41 in the first driving circuit 20a and the semiconductor layer 41 in the second driving circuit 20b are arranged line-symmetrical with respect to the central line A of the element group G, and are arranged at the same positions in the X direction. That is, as shown in FIG. 8, it is preferable that both the semiconductor layer 41 in the first driving circuit 20a and the semiconductor layer 41 in the second driving circuit 20b are formed to span from a straight line m1 to a straight line m2 both extending in the Y direction while being spaced apart from each other. It is also preferable that the semiconductor layer 41 in the first driving circuit 20a and the semiconductor layer 41 in the second driving circuit 20b have the same shape and size. It is further preferable that the semiconductor layer 41 in the first driving circuit 20a and the semiconductor layer 41 in the second driving circuit 20b are equal distances (dy1 shown in FIG. 8) from the central line A.

Similarly, the semiconductor layer 51 of the selecting transistor Tr of the first driving circuit 20a is arranged opposite the semiconductor layer 51 of the selecting transistor Tr of the second driving circuit 20b with respect to the first area J. As shown in FIG. 8, it is preferable that the semiconductor layer 51 in the first driving circuit 20a and the semiconductor layer 51 in the second driving circuit 20b are arranged line-symmetrical with respect to the central line A of the element group G, are at the same positions in the X direction, have the same shape and size and are equal distances (dy2 shown in FIG. 8) from the central line A. Similarly, the second electrode L2 of the capacitor element C of the first driving circuit 20a is arranged opposite the second electrode L2 of the capacitor element C of the second driving circuit 20b with respect to the first area J. As shown in FIG. 8, it is preferable that both the second electrode L2 in the first driving circuit 20a and the second electrode L2 in the second driving circuit 20b are formed to span from a straight line m3 to a straight line m4 both extending in the Y direction while being spaced apart from each other, have the same shape and size and are equal distances (dy3 shown in FIG. 8) from the central line A.

The semiconductor layer of at least one transistor included in the third driving circuit 20c is arranged opposite the semiconductor layer of at least one transistor included in the fourth driving circuit 20d with respect to the first area J. More specifically, the semiconductor layer 41 of the driving transistor Td of the third driving circuit 20c is arranged opposite the semiconductor layer 41 of the driving transistor Td of the fourth driving circuit 20d with respect to the first area J. In further detail, it is preferable that the semiconductor layer 41 in the third driving circuit 20c and the semiconductor layer 41 in the fourth driving circuit 20d are arranged line-symmetrical with respect to the central line A of the element group G, and are arranged at the same positions in the X direction. That is, as shown in FIG. 8, both the semiconductor layer 41 in the third driving circuit 20c and the semiconductor layer 41 in the fourth driving circuit 20d are formed to span from a straight line m5 to a straight line m6 both extending in the Y direction while being spaced apart from each other. It is also preferable that the semiconductor layer 41 in the third driving circuit 20c and the semiconductor layer 41 in the fourth driving circuit 20d have the same shape and size. It is further preferable that the semiconductor layer 41 in the third driving circuit 20c and the semiconductor layer 41 in the fourth driving circuit 20d are equal distances (dy1 shown in FIG. 8) from the central line A.

Similarly, the semiconductor layer 51 of the selecting transistor Tr of the third driving circuit 20c is arranged opposite the semiconductor layer 51 of the selecting transistor Tr of the fourth driving circuit 20d with respect to the first area J. As shown in FIG. 8, it is preferable that the semiconductor layer 51 in the third driving circuit 20c and the semiconductor layer 51 in the fourth driving circuit 20d are arranged line-symmetrical with respect to the central line A of the element group G, commonly positioned in the X direction, have the same shape and size and are equal distances (dy2 shown in FIG. 8) from the central line A. Similarly, the second electrode L2 of the capacitor element C of the third driving circuit 20c is arranged opposite the second electrode L2 of the capacitor element C of the fourth driving circuit 20d with respect to the first area J. As shown in FIG. 8, it is preferable that both the second electrode L2 in the third driving circuit 20c and the second electrode L2 in the fourth driving circuit 20d are formed to span from a straight line m7 to a straight line m8 both extending in the Y direction while being spaced apart from each other, have the same shape and size and are equal distances (dy3 shown in FIG. 8) from the central line A.

### B. Second Embodiment

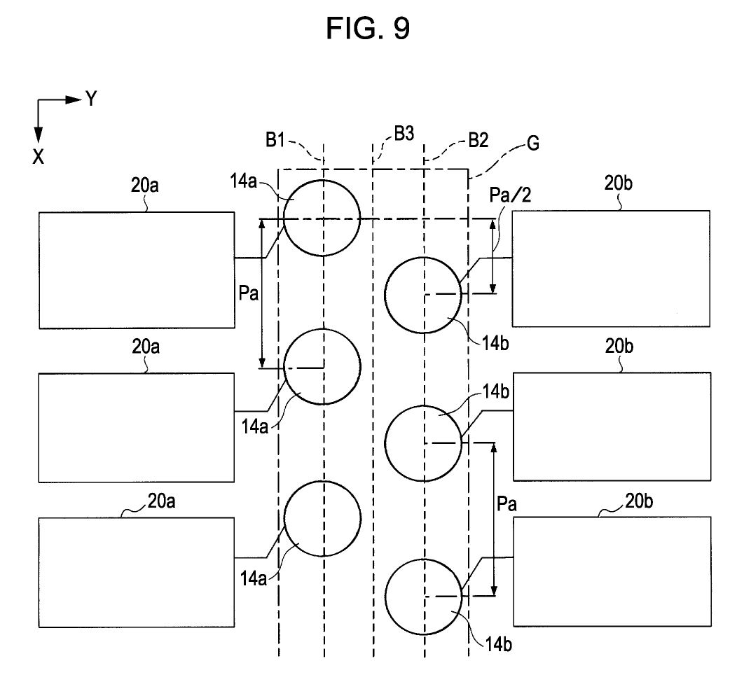

FIG. 9 is a plan view schematically showing a configuration of a light emitting device 10 of a second embodiment of the invention. As shown in FIG. 9, each of a plurality of first light emitting elements 14a is arranged, at a pitch Pa, centered on a straight line B1 extending in the X direction. Each of a plurality of second light emitting elements 14b is arranged, at the pitch Pa, centered on a straight line B2 extending in the X direction while being spaced with the straight line B1.

As shown in FIG. 9, each of the first light emitting elements 14a and each of the second light emitting elements 14b are arranged at different positions in the X direction, and a distance between the first light emitting element 14a and the second light emitting element 14b being adjacent in the X direction is Pa/2. That is, as the light emitting elements 14 belonging to the element group G are arranged so as to form an alternating pattern along two lines, the distance between the light emitting elements 14 of the element group G being adjacent in the X direction (i.e., the distance between the first light emitting element 14a and the second light emitting element 14b being adjacent in the X direction, Pa/2) can be made smaller than that in the configuration in which the plural light emitting elements 14 are arranged on one line at the pitch Pa. Thus, the configuration of the second embodiment has an advantage in that the light emitting device 10 can form, on the image carrier, an image (latent image) that is more precise than that formed in the configuration of the first embodiment. In other words, if the pitch of the light emitting elements is equal to that of the first embodiment, the light emitting device 10 can have a greater light emitting area than that of the first embodiment. Thus, the light emitting device 10 of the second embodiment can reduce density of a current flowing through the light emitting elements and have a longer lifetime.

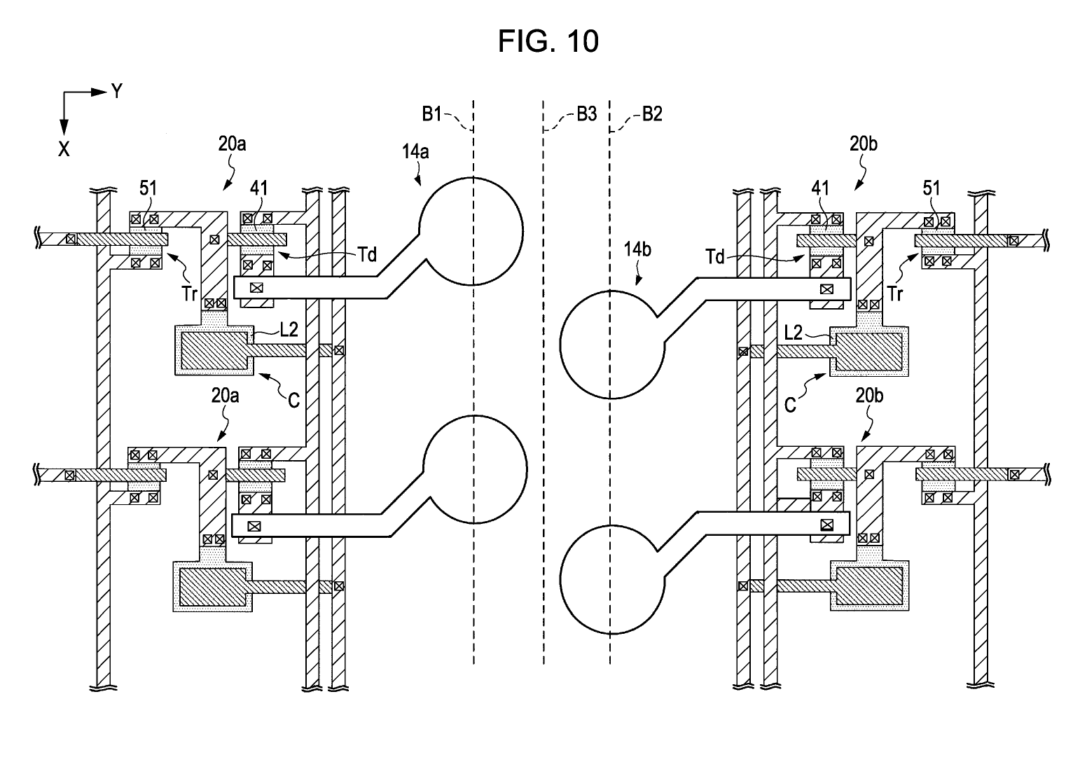

FIG. 10 is a plan view specifically showing a configuration of the light emitting device 10 of the second embodiment. As shown in FIG. 9 and FIG. 10, each of the first driving circuits 20a and each of the second driving circuits 20b are arranged line-symmetrical with respect to a straight line B3 which is equally distant from the lines B1 and B2. More specifically, in FIG. 10, the arrangement (layout) of the elements of the first driving circuit 20a and the arrangement of the elements of the second driving circuit 20b are line-symmetrical with respect to the line B3 that is a central line of the element group G, similarly to the first embodiment.

### C. Modifications

The invention is not limited to the embodiments described above, and can be modified, e.g., as shown below. Two or more modifications shown below can be combined.

(1) First Modification

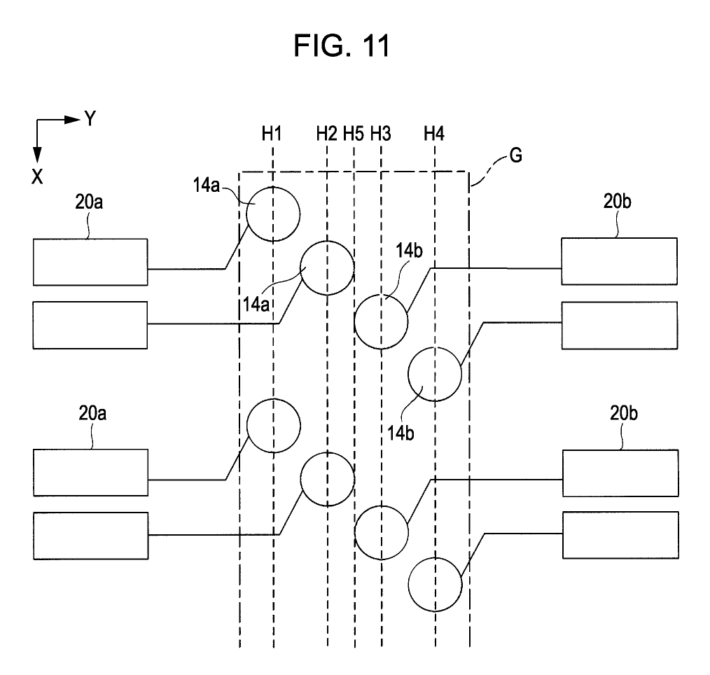

The light emitting elements 14 belonging to the element group G of the second embodiment are arranged so as to form an alternating pattern along two lines. The number of lines is not limited to two but is optional. As shown in FIG. 11, e.g., the light emitting elements 14 belonging to the element group G can be arranged so as to form an alternating pattern along four lines.

In FIG. 11, the plural first light emitting elements 14a are arranged positioned on straight lines H1 and H2 extending in the X direction while being spaced apart from each other. As shown in FIG. 11, the first light emitting elements 14a are unevenly positioned in the X direction, and arranged so as to form an alternating pattern along two lines.

The plural second light emitting elements 14b are arranged positioned on straight lines H3 and H4 extending in the X direction while being spaced apart from each other. As shown in FIG. 11, the second light emitting elements 14b are unevenly positioned in the X direction, and arranged so as to form an alternating pattern along two lines.

FIG. 11 shows a straight line H5 that is equally distant from the lines H1 and H4, and is equally distant from the lines H2 and H3. The line H5 corresponds to a central line of the element group G. In the configuration shown in FIG. 11, too, the first driving circuit 20a and the second driving circuit 20b are arranged line-symmetrical with respect to the line H5, the central line of the element group G.

(2) Second Modification

The arrangement of the elements of the first driving circuit 20a and the arrangement of the elements of the second driving circuit 20b of the above embodiments are line-symmetrical with the central line of the element group G (the line A or the line B3). The arrangement of the elements is not limited to the above, and only some of the elements of the driving circuits 20 (20a, 20b) positioned opposite each other with respect to the central line of the element group G can be arranged line-symmetrical with the central line of the element group G.

For example, only the driving transistors Td of the driving circuits 20 (20a, 20b) positioned opposite each other with respect to the central line of the element group G can be arranged line-symmetrical with the central line of the element group G. Only the selecting transistors Tr can be arranged line-symmetrical with the central line of the element group G. In short, it is enough that the transistor included in the first driving circuit 20a and the transistor included in the second driving circuit 20b are arranged line-symmetrical with the central line of the element group G.

The elements of the driving circuits 20 (20a, 20b) positioned opposite each other with respect to the central line of the element group G need not to be line-symmetrical with the central line of the element group G. In FIG. 4, e.g., the semiconductor layer 41 of the first driving circuit 20a and the semiconductor layer 41 of the second driving circuit 20b can be arranged unequally distant in the Y direction from the central line of the element group G. Even in such an arrangement, if the semiconductor layer 41 of the first driving circuit 20a and the semiconductor layer 41 of the second driving circuit 20b are arranged at the same positions in the X direction, variation of the amount of the laser light irradiated to the semiconductor layer 41 of each of the driving circuits 20 (20a, 20b) positioned opposite each other with respect to the central line of the element group G can be reduced. Thus, variation of characteristics of the driving transistors Td included in the driving circuits 20 (20a, 20b) positioned opposite each other with respect to the central line of the element group G can be reduced.

The semiconductor layer 41 of the driving transistor Td exemplifies the arrangement of the light emitting device 10 as described above, and so does the semiconductor layer 51 of the selecting transistor Tr. In short, it is enough that the semiconductor layer of the transistor included in each of the first driving circuits 20a and the semiconductor layer of the transistor included in each of the second driving circuits 20b are arranged at the same positions in the X direction.

(3) Third Modification

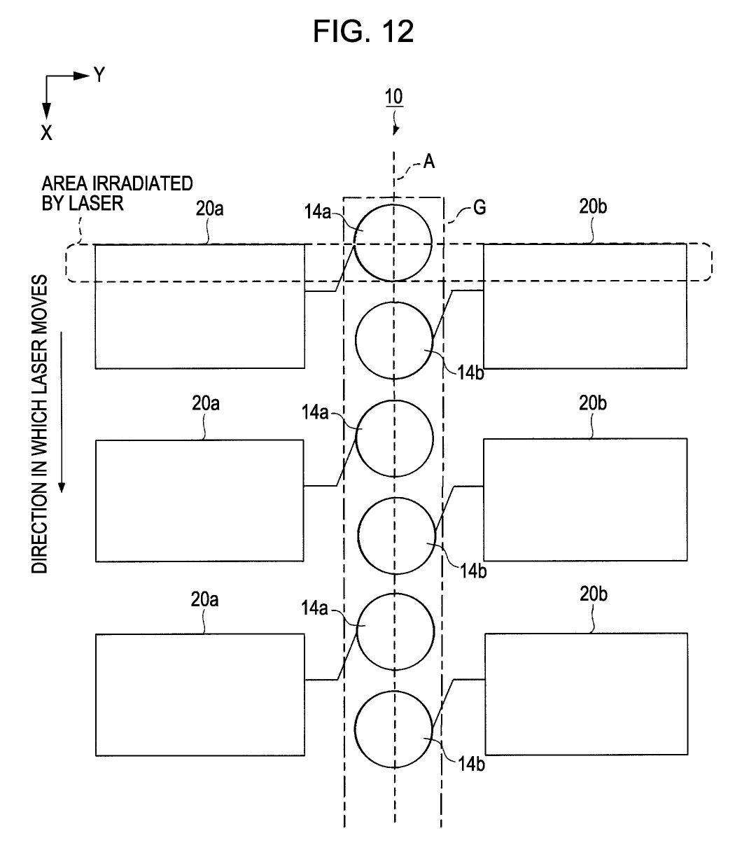

How to irradiate the semiconductor layers by means of laser can be modified from the above examples. As shown in FIG. 12, e.g., the laser can irradiate the semiconductor layers while successively moving an area of irradiation in the X direction, and the area once irradiated can extend in the Y direction. In the configuration shown in FIG. 12, the amount of the laser light does not vary depending on the position in the longer side direction (the Y direction) of the area once irradiated, but may vary shot by shot in some cases. The arrangement of the elements of the first driving circuit 20a and the arrangement of the elements of the second driving circuit 20b of the first embodiment are line-symmetrical with respect to the central line A. Thus, variation of the amount of the laser light irradiated to the driving circuits 20 (20a, 20b) arranged opposite to each other with respect to the central line A can be reduced even if the amount of the laser light varies depending on the position in the X direction. That is, according to the configuration of the first embodiment, variation of characteristics of the driving circuits 20 (20a, 20b) arranged opposite to each other with respect to the central line A can be reduced even in a case as shown in FIG. 12.

(4) Fourth Modification

The light emitting element 14 of the above embodiments is, e.g., an organic electroluminescent element. The light emitting element 14 is not limited to the above, and may be an inorganic electroluminescent light emitting diode or an LED (light emitting diode). In short, the light emitting element 14 may be any kind of element as long as being able to emit light with brightness according to electrical energy applied thereto. It is preferable, though, that the light emitting element 14 is an active dc-driven light emitting element, and is applied to a light emitting device controlled by using a thin film transistor.

### D. Electronic Apparatus

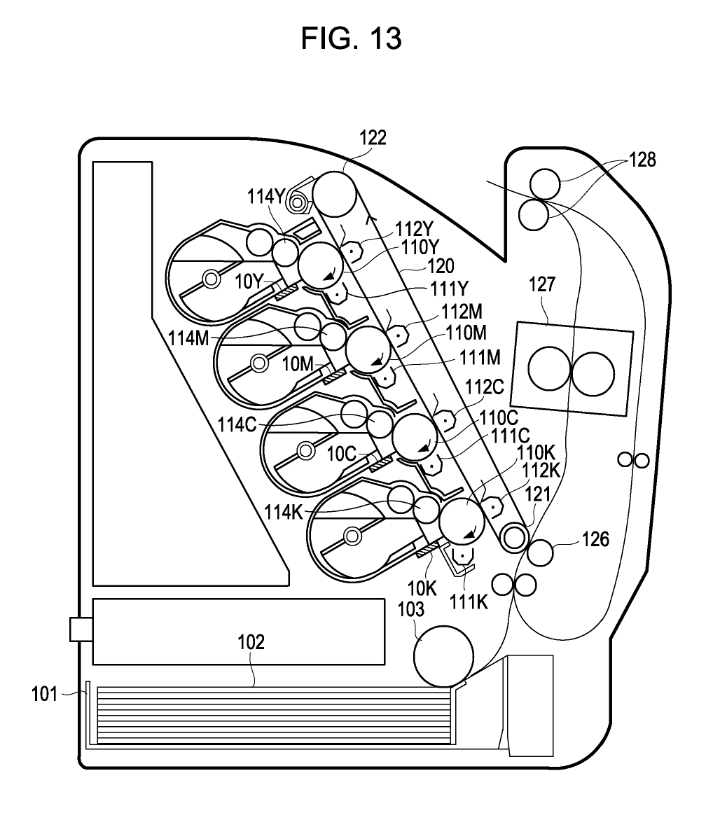

Then, an image forming device of an embodiment of the electronic apparatus of the invention will be described with reference to FIG. 13. The image forming device is a full-color image forming device of a tandem type configured to use a middle transfer belt.

The image forming device has four equally configured light emitting devices 10K, 10C, 10M and 10Y arranged opposite image forming faces 110 of four equally configured photosensitive drums (image carriers) 110K, 110C, 110M and 110Y. The light emitting devices 10K, 10C, 10M and 10Y are similarly configured as the light emitting device 10 of the above embodiments.

As shown in FIG. 13, the image forming device has a driving roller 121 and a following roller 122. An endless middle transfer belt 120 wound around the rollers 121 and 122 rotates around the rollers 121 and 122 as shown by an arrow. Although not shown, the image forming device may have what provides the middle transfer belt 120 with tension such as a tension roller.

Around the middle transfer belt 120, the four photosensitive drums 110K, 10C, 110M and 110Y each of which has a photosensitive layer on its outer face are arranged at a determined separation between each other. The subscripts “K”, “C”, “M” and “Y” mean that they are used for forming black, cyan, magenta and yellow noticeable images, respectively. Other members shown in FIG. 13 are similarly given the subscripts. The photosensitive drums 110K, 110C, 110M and 110Y are rotationally driven in synchronization with the drive of the middle transfer belt 120.

Around the photosensitive drums 110 (K, C, M, Y), corona chargers 111 (K, C, M, Y), the light emitting devices 10 (K, C, M, Y) and developing units 114 (K, C, M, Y) are arranged, respectively. The corona chargers 111 (K, C, M, Y) uniformly charge image forming faces (outer faces) 110A of the corresponding photosensitive drums 110 (K, C, M, Y), respectively. The light emitting devices 10 (K, C, M, Y) write electrostatic latent images on the charged image forming faces 110A of the photosensitive drums. The light emitting devices 10 (K, C, M, Y) have a plurality of light emitting elements 20 arranged along a mother line (in a main scanning direction). The plural light emitting devices 20 write the electrostatic latent images by irradiating the photosensitive drums 110 (K, C, M, Y) by light. The developing units 114 (K, C, M, Y) form noticeable images (i.e., visible images) by putting toner as developer on the electrostatic latent images.

The noticeable images of black, cyan, magenta and yellow formed by such stations for forming monochrome images of the four colors are overlapped on the middle transfer belt 120 by being successively primarily transferred onto the middle transfer belt 120, and consequently form a full-color noticeable image. Inside the middle transfer belt 120, four primary transfer corotrons (transferring units) 112 (K, C, M, Y) are arranged. The primary transfer corotrons 112 (K, C, M, Y) are arranged close to the photosensitive drums 110 (K, C, M, Y), respectively, and transfers the noticeable images on the middle transfer belt 120 that passes between the photosensitive drums and the primary transfer corotrons by electrostatically absorbing the noticeable images from the photosensitive drums 110 (K, C, M, Y).

The image forming device of the embodiment has a pick-up roller 103 configured to provide a sheet 102, i.e., an object (recording medium) on which the image is finally formed, one by one from a paper feed cassette 101 to a nip between a secondary transfer roller 126 and the middle transfer belt 120 that is in contact with the driving roller 121. The noticeable full-color image on the middle transfer belt 120 is collectively secondarily transferred on a face of the sheet 102 by the secondary transfer roller 126. The sheet 102 passes a pair of fixing rollers 127, i.e., a fixing unit, so that the noticeable full-color image is fixed on the sheet 102. Then, a pair of paper output rollers 128 provides a paper output cassette arranged on an upper portion of the device with the sheet 102.

The image forming device shown in FIG. 13 uses a light source (exposing unit) that adopts an OLED element as a light emitting element, and thus can be downsized in comparison with a device that uses a laser scanning optical system. The light emitting device 10 of the invention can be applied to an image forming device other than the one described above. The light emitting device 10 of the invention can be applied to, e.g., an image forming device configured§ to transfer a noticeable image directly from a photosensitive drum to a sheet without using a middle transfer belt, or an image forming device configured to form a monochrome image.

The light emitting device of the invention is applied not only to exposing photosensitive material but, e.g., to an image reading device such as a scanner as a line type light head (illuminating device) configured to illuminate by light an object to be read such as a script. The image reading device of this kind may be an image reading unit of a scanner, a barcode reader or a 2D image code reader configured to read a 2D image code such as a QR code (trademark). A light emitting device including a plurality of light emitting elements arranged on a plane can be adopted as a backlight unit arranged on a back of a liquid crystal panel. A light emitting device including a plurality of light emitting elements arranged in a matrix form can be adopted as a display device of various electronic apparatuses.

What is claimed is:

1. A light emitting device, comprising:
an element group that includes a plurality of first light emitting elements arranged in a first direction;
a plurality of first driving circuits, each driving circuit of the plurality of first driving circuits being configured to drive a corresponding light emitting element of the plurality of first light emitting elements belonging to the element group; and
a plurality of second driving circuits, each driving circuit of the plurality of second driving circuits being configured to drive a corresponding light emitting element of a plurality of second light emitting elements belonging to the element group, at least a portion of the element group being arranged between the first driving circuits and the second driving circuits in a second direction that is different from the first direction, a semiconductor layer of at least one transistor included in each of the first driving circuits and a semiconductor layer of at least one transistor included in each of the second driving circuits being arranged at a same position in the first direction.

2. The light emitting device of claim 1, further comprising:
a first driving transistor that is provided on a path of a current supplied from each driving circuit of the plurality of first driving circuits to the corresponding light emitting element of the first light emitting elements;
a second driving transistor that is provided on a path of a driving current supplied from each driving circuit of the plurality of second driving circuits to the corresponding light emitting element of the second light emitting elements; and
a semiconductor layer of the first driving transistor and a semiconductor layer of the second driving transistor that are arranged at a same position in the first direction.

3. The light emitting device of claim 1, further comprising:
a first selecting transistor within each driving circuit of the plurality of first driving circuits that is configured to determine whether a data signal is provided to a gate of a first driving transistor provided on a path of a driving current supplied to the corresponding light emitting element of the plurality of first light emitting elements;
a second selecting transistor within each driving circuit of the plurality of second driving circuits that is configured to determine whether a data signal is provided to a gate of a second driving transistor provided on a path of a driving current supplied to the corresponding light emitting element of the plurality of second light emitting elements; and
a semiconductor layer of the first selecting transistor and a semiconductor layer of the second selecting transistor that are arranged at a same position in the first direction.

4. The light emitting device of claim 2, further comprising:
a first capacitor element within each driving circuit of the plurality of first driving circuits that has a first electrode and a second electrode formed from the same layer as the semiconductor layer of the first driving transistor included in the first driving circuit, the first capacitor element being configured to maintain a gate voltage of the first driving transistor; and
a second capacitor element within each driving circuit of the plurality of second driving circuits that has a third electrode and a fourth electrode formed from the same layer as the semiconductor layer of the second driving transistor included in the second driving circuit, the second capacitor element being configured to maintain a gate voltage of the second driving transistor, the first capacitor element and the second capacitor element are arranged at a same position in the first direction.

5. The light emitting device of claim 2, further comprising:
a first power supply line that drives a current flow through the first driving transistor in a first current flow direction; and
a second power supply line that drives a current flow through the second driving transistor in the first current flow direction.

6. The light emitting device of claim 1, further comprising:
a central line of symmetry that extends in the first direction and that passes through a center of the respective first light emitting elements and a center of the respective second light emitting elements of the element group, the transistor included in the first driving circuit and the transistor included in the second driving circuit arranged line-symmetrical with respect to the central line of the element group.

7. The light emitting device of claim 1, further comprising:
a central line of symmetry that extends in the first direction and that passes through a center of the respective first light emitting elements and a center of the respective second light emitting elements of the element group, an arrangement of a plurality of elements of the first driving circuit and an arrangement of a plurality of elements of the second driving circuit being line-symmetrical with respect to the central line of the element group.

8. The light emitting device of claim 1, the element group further comprising:
an alternating arrangement of the first light emitting elements and the second light emitting elements.

9. A light emitting device, comprising:
a substrate including a first area, a second area and a third area, the first area being positioned between the second area and the third area;
an element group including a first light emitting element, a second light emitting element, a third light emitting element and a fourth light emitting element, the element group being arranged in the first area;
a first driving circuit arranged in the second area, the first driving circuit being configured to drive the first light emitting element, the first driving circuit including a first transistor;
a second driving circuit arranged in the third area, the second driving circuit being configured to drive the second light emitting element, the second driving circuit including a second transistor, a semiconductor layer of the second transistor being arranged opposite a semiconductor layer of the first transistor with respect to the first area;
a third driving circuit arranged in the second area, the third driving circuit being configured to drive the third light emitting element, the third driving circuit including a third transistor; and
a fourth driving circuit arranged in the third area, the fourth driving circuit being configured to drive the fourth light emitting element, the fourth driving circuit including a fourth transistor, a semiconductor layer of the fourth transistor being arranged opposite a semiconductor layer of the third transistor with respect to the first area.

10. A light emitting device, comprising:
a substrate including a first area, a second area and a third area, the first area being positioned between the second area and the third area;
an element group including a first light emitting element, a second light emitting element, a third light emitting element and a fourth light emitting element, the element group being arranged in the first area;
a first driving transistor arranged in the second area, the first driving transistor being arranged on a path of a driving current provided to the first light emitting element;
a second driving transistor arranged in the third area, the second driving transistor being arranged on a path of a driving current provided to the second light emitting element, a semiconductor layer of the second driving transistor being arranged opposite a semiconductor layer of the first driving transistor with respect to the first area;
a third driving transistor arranged in the second area, the third driving transistor being arranged on a path of a driving current provided to the third light emitting element; and
a fourth driving transistor arranged in the third area, the fourth driving transistor being arranged on a path of a driving current provided to the fourth light emitting element, a semiconductor layer of the fourth driving transistor being arranged opposite a semiconductor layer of the third driving transistor with respect to the first area.

11. An electronic apparatus, comprising:
the light emitting device of claim 1.

12. A light emitting device, comprising:
an element group that includes a plurality of first light emitting elements arranged in a first direction along a common central axis;
a plurality of first driving circuits, each driving circuit of the plurality of first driving circuits configured to drive a corresponding light emitting element of the plurality of first light emitting elements belonging to the element group; and
a plurality of second driving circuits, each driving circuit of the plurality of second driving circuits configured to drive a corresponding light emitting element of a plurality of second light emitting elements belonging to the element group, wherein each driving circuit of the plurality of first driving circuits is positioned on a first side of the central axis opposite a driving circuit of the plurality of second driving circuits on a second side of the central axis, resulting in a bilaterally symmetrical placement of the first driving circuits and the second driving circuits relative to the central axis.

13. The light emitting device of claim 12, further comprising:
a first driving transistor that is provided on a path of a current supplied from each driving circuit of the plurality of first driving circuits to the corresponding light emitting element of the first light emitting elements;
a second driving transistor that is provided on a path of a driving current supplied from each driving circuit of the plurality of second driving circuits to the corresponding light emitting element of the second light emitting elements; and
a semiconductor layer of the first driving transistor and a semiconductor layer of the second driving transistor that are bilaterally symmetrical to each other with respect to the central axis.

14. The light emitting device of claim 12, further comprising:
a first selecting transistor within each driving circuit of the plurality of first driving circuits that is configured to determine whether a data signal is provided to a gate of a first driving transistor provided on a path of a driving current supplied to the corresponding light emitting element of the plurality of first light emitting elements;
a second selecting transistor within each driving circuit of the plurality of second driving circuits that is configured to determine whether a data signal is provided to a gate of a second driving transistor provided on a path of a driving current supplied to the corresponding light emitting element of the plurality of second light emitting elements; and
a semiconductor layer of the first selecting transistor and a semiconductor layer of the second selecting transistor that are bilaterally symmetrical to each other with respect to the central axis.

15. The light emitting device of claim 13, further comprising:
a first capacitor element within each driving circuit of the plurality of first driving circuits that has a first electrode and a second electrode formed from the same layer as the semiconductor layer of the first driving transistor included in the first driving circuit, the first capacitor element being configured to maintain a gate voltage of the first driving transistor; and
a second capacitor element within each driving circuit of the plurality of second driving circuits that has a third electrode and a fourth electrode formed from the same layer as the semiconductor layer of the second driving transistor included in the second driving circuit, the second capacitor element being configured to maintain a gate voltage of the second driving transistor, the first capacitor element and the second capacitor element bilaterally symmetrical to each other with respect to the central axis.

16. The light emitting device of claim 13, further comprising:
a first power supply line that drives a current flow through the first driving transistor in a first current flow direction; and
a second power supply line that drives a current flow through the second driving transistor in the first current flow direction.

17. The light emitting device of claim 12, further comprising:
a central line of symmetry that extends in the first direction and that passes through a center of the respective first light emitting elements and a center of the respective second light emitting elements of the element group, the transistor included in the first driving circuit and the transistor included in the second driving circuit arranged in bilaterally symmetry with each other with respect to the central axis.

18. The light emitting device of claim 12, the element group further comprising:
an alternating arrangement of first light emitting elements and second light emitting elements.
